(19) United States
(12) Patent Application Publication
(10) Pub. No.: US 2026/0031584 A1
(43) Pub. Date: Jan. 29, 2026

(54) ADAPTER DEVICE

(71) Applicant: K.S. TERMINALS INC., CHANGHUA COUNTY (TW)

(72) Inventor: PAO-YEN HUANG, CHANGHUA COUNTY (TW)

(21) Appl. No.: 18/785,709

(22) Filed: Jul. 26, 2024

(51) Int. Cl. H01R 31/06; H01R 13/627; H01R 13/629

(52) U.S. Cl. CPC H01R 31/06; H01R 13/6275; H01R 13/629; H01R 2201/26

(57) ABSTRACT

An adapter device comprises an internal locking assembly and an external press button. The locking assembly includes a pushing block, an actuating block, and two sliding blocks. The actuating block is connected to a mounting base connector, a connector locking mechanism, and a press button connector. Each sliding block is connected to a limiting member and has a sliding protrusion. When a charging connector is inserted into the adapter device, it pushes the sliding protrusions, allowing the press button to be pressed. This allows the adapter device to connect to or disconnect from a mounting base.

### FIELD OF INVENTION

The present disclosure relates to an adapter device for charging connectors, specifically an adapter device that converts from a NACS interface to a TYPE1 interface.

### BACKGROUND OF THE INVENTION

With the increasing popularity of electric vehicles, more and more public places are equipped with electric charging stations. However, different brands of electric vehicles may use different charging interfaces. Therefore, some electric charging station charging connectors are equipped with adapter devices to prevent situations where vehicle owners find a charging station but are unable to charge their vehicles.

### SUMMARY OF THE INVENTION

Based on the above deficiencies, the purpose of the present disclosure is to provide a charging connector adapter device with a mistake-proofing mechanism, specifically an adapter device that converts from a NACS interface to a TYPE1 interface.

According to the purpose of the present disclosure, an adapter device is provided, comprising a body having an interface converter inside. The rear end of the interface converter is an interface port, and the front end is equipped with a docking connector. A locking assembly is provided on the outside of the interface converter, and a press button is provided on the outside of the body. The locking assembly includes: a pushing block; an actuating block connected to a mounting base connector, a connector locking mechanism, and a press button connector, wherein when the mounting base connector is pushed by the pushing block to swing toward the direction of the interface converter, it simultaneously causes the actuating block to displace; and at least one sliding block, provided on either the left or right side of the interface converter, wherein the at least one sliding block is connected to a limiting member and has a sliding protrusion protruding into the interface port of the interface converter, when the sliding protrusion is squeezed, the sliding block slides, causing the limiting member to swing away from the press button connector.

Wherein the docking connector is connected to a mounting base, which has a pushing member that pushes the pushing block to move.

Wherein the mounting base has a positioning part, and the press button has a hooking part that positions at the positioning part.

Wherein the interface converter is connected to a charging connector. The outer surface of the charging connector has a positioning groove, and the connector locking mechanism has a positioning hook that positions in the positioning groove.

Wherein the limiting member has a limiting protrusion.

Wherein the actuating block has a primary alignment track and a secondary alignment channel. A first connecting rod is provided in the primary alignment track, and a second connecting rod is provided in the secondary alignment channel.

Wherein the press button connector has a connecting part and at least one swing arm. The at least one swing arm extends downward from the connecting part toward either the left or right side of the interface converter and is disposed on one side of the second connecting rod, while the connecting part is connected to the press button.

Wherein there is a gap between the connecting part of the press button connector and the interface converter. When the sliding protrusion is not squeezed, the limiting protrusion of the limiting member is located within this gap.

Wherein the connecting part of the press button connector has a sliding groove with an axle rod provided inside. Underneath the connecting part of the press button connector, a spring is also provided in the gap.

Wherein the mounting base connector has a push part and at least one connecting arm. The at least one connecting arm extends downward from the push part toward either the left or right side of the interface converter and is disposed on one side of the first connecting rod, and the push part is adjacent to the pushing block.

### BRIEF DESCRIPTION OF THE DRAWINGS

FIG. 1 is a schematic diagram of the adapter device in the embodiment.

FIG. 2 is a rear view of the adapter device in the embodiment.

FIG. 3 is a usage diagram of the adapter device in the embodiment.

FIG. 4 is a schematic diagram of the adapter device in the embodiment before it is removed from the mounting base.

FIGS. 5 to 7 are operational decomposition diagrams showing the separation of the adapter device from the mounting base after being connected to the charging connector in the embodiment.

### DETAILED DESCRIPTION OF THE PREFERRED EMBODIMENTS

In order to clearly describe the specific implementation methods, structures, and achieved effects of the present disclosure, the following embodiments are provided and described with reference to the drawings:

The directional descriptions such as “front”, “rear”, “up”, “down”, “left”, “right” used in this text are for ease of understanding only. The present disclosure is not limited to these directions and can be adjusted according to actual situations. In the present disclosure, the X direction marked in the drawings represents the left-right direction, the Y direction represents the up-down direction, and the Z direction represents the front-rear direction.

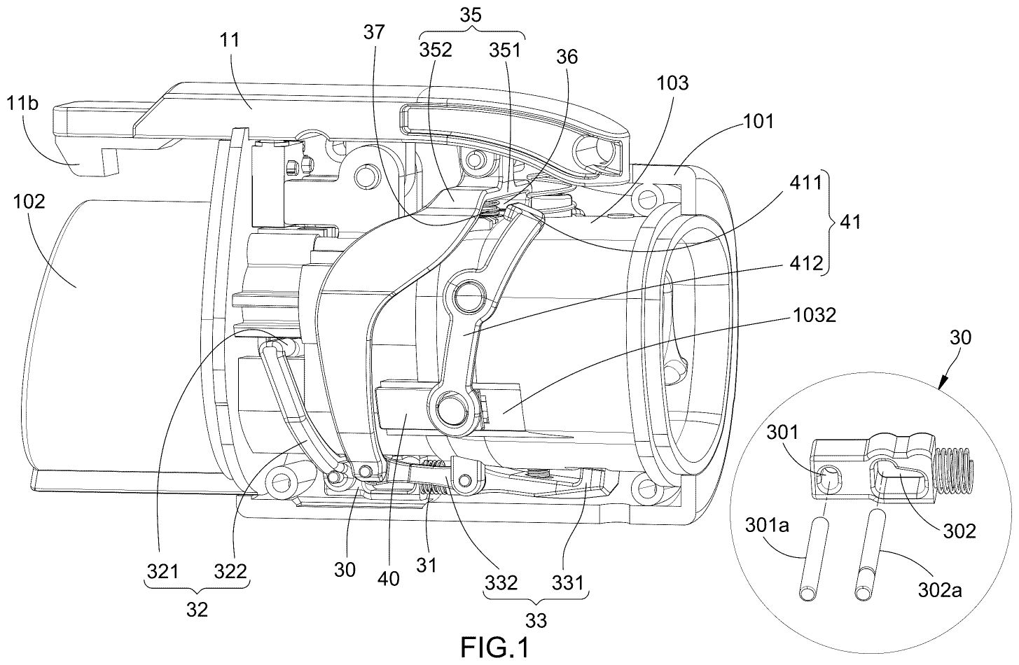

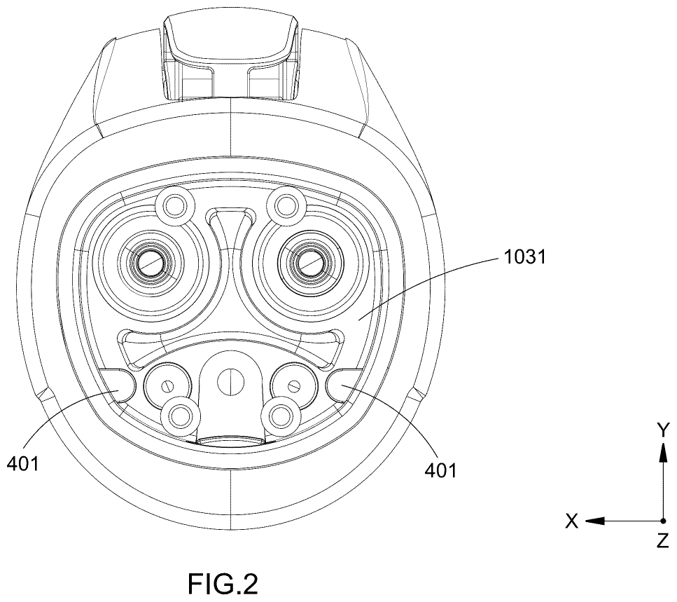

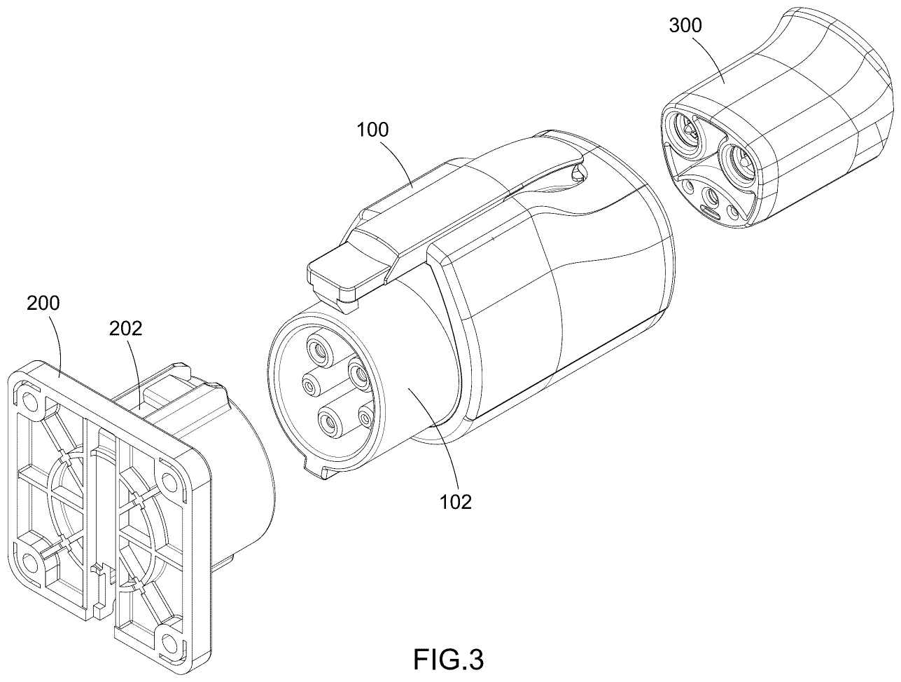

Reference is made to FIGS. 1 to 7, which depict an adapter device 100 having a body 101. The front end of the body 101 is connected to a mounting base 200, and the rear end is for insertion of a charging connector 300. Inside the body 101 is an interface converter 103, and the rear end of the interface converter 103 is an interface port 1031 into which the charging connector 300 is inserted. The front end of the interface converter 103 is equipped with a docking connector 102, which is used to connect to the mounting base 200.

In this embodiment, a press button 11 is also provided on the outside of the body 101, and a locking assembly is provided on the outside of the interface converter 103. The press button 11 has a hooking part 11b, which is positioned in a positioning part 202 of the mounting base 200.

The locking assembly includes a pushing block 20, an actuating block 30, and at least one sliding block 40. The actuating block 30 is located under the interface converter 103 via a spring 31, and has a primary alignment track 301 and a secondary alignment channel 302. A first connecting rod 301a is provided in the primary alignment track 301, and a second connecting rod 302a is provided in the secondary alignment channel 302. The secondary alignment channel 302 has an L-shaped profile with a long side formed along the Z direction and a short side formed vertically along the Y direction at the rear of the long side. The second connecting rod 302a is movable within the secondary alignment channel 302.

A mounting base connector 32 having a push part 321 and two connecting arms 322. The two connecting arms 322 extend downward from both sides of the push part 321 toward the left and right sides of the interface converter 103, and are disposed on the left and right sides of the first connecting rod 301a, respectively, where the push part 321 is adjacent to the pushing block 20. When the interface converter 103 is inserted into the mounting base 200, a pushing member 201 of the mounting base 200 pushes the pushing block 20 to be displaced, and the mounting base connector 32 is pushed by the pushing block 20, causing the mounting base connector 32 to swing along the Z direction toward the interface converter 103, and simultaneously causing the actuating block 30 to move along the Z direction.

A connector locking mechanism 33 having a positioning hook 331 and two positioning arms 332. The front ends of the two positioning arms 332 are connected to the left and right sides of the second connecting rod 302a, respectively, and the positioning hook 331 is supported by a compression spring 34, which allows it to swing relative to the interface converter 103.

A press button connector 35 having a connecting part 351 and two swing arms 352. The connecting part 351 is connected to the press button 11 and has a sliding groove 351a with an axle rod 351b provided inside. The axle rod 351b can move within the sliding groove 351a, and the profile of the sliding groove 351a is oval-shaped and formed along the Y direction. Wherein the axle rod 351b moves simultaneously with the second connecting rod 302a, thereby allowing the press button connector 35 to swing up and down.

The two swing arms 352 extend downward from the connecting part 351 toward the left and right sides of the interface converter 103, respectively, and are disposed on the second connecting rod 302a and positioned on the outside of the two positioning arms 332. A gap 36 is provided between the connecting part 351 of the press button connector 35 and the interface converter 103, which allows the press button 11 to be pressed down. Additionally, a spring 37 is provided in the gap 36, the placement of this spring 37 allowing the second connecting rod 302a to displace within the secondary alignment channel 302, further allowing the positioning hook 331 to swing downward and out of a positioning groove 3001.

In the embodiment, two sliding blocks 40 are provided in slide rails 1032 on the left and right sides of the interface converter 103. The two sliding blocks 40 are each connected to a limiting member 41. Each sliding block 40 has a sliding protrusion 401 protruding into the interface port 1031 of the interface converter 103. Each limiting member 41 has a limiting swing arm 412 and a limiting protrusion 411. The limiting protrusion 411 extends forward from the end of the limiting swing arm 412, giving the limiting member 41 a generally L-shaped appearance. When the sliding protrusion 401 is not squeezed by the charging connector 300, the limiting protrusion 411 is located within the gap 36, creating a limiting effect that prevents the press button 11 from being pressed due to lack of downward space. When the sliding protrusion 401 is squeezed by the charging connector 300, the sliding block 40 moves forward along the Z direction, causing the limiting protrusion 411 to swing away from the gap 36. At this time, there is no limiting structure in the gap 36, which allows the press button 11 to be pressed down.

By providing the sliding blocks 40 on both the left and right sides of the interface converter 103, the two connecting arms 322 of the mounting base connector 32, and the two swing arms 352 of the press button connector 35, the overall structural strength and mechanism stability can be improved. If the structure on one side fails to function, the mechanism on the other side can still maintain operation, allowing the adapter device 100 to remain usable. In other embodiments, the number of the sliding blocks 40, the connecting arms 322, and the swing arms 352 can be one and located on the same side, which can still maintain the operation of the mechanism of the adapter device 100.

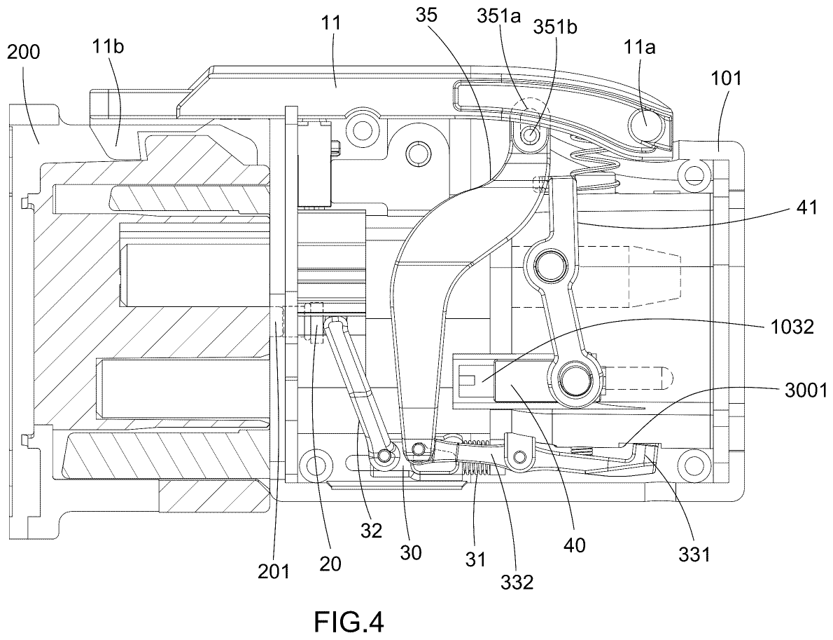

Reference is made to FIG. 4. When the adapter device 100 is inserted into the mounting base 200 and not connected to the charging connector 300, since the sliding protrusion 401 is not squeezed by the charging connector 300, the press button 11 cannot be pressed due to lack of downward space. This prevents users from removing the adapter device 100 from the mounting base 200, thereby preventing the adapter device 100 from being stolen by malicious persons. At this time, the second connecting rod 302a is located at the short side of the secondary alignment channel 302, and the axle rod 351b of the press button connector 35 is located at the bottom of the sliding groove 351a.

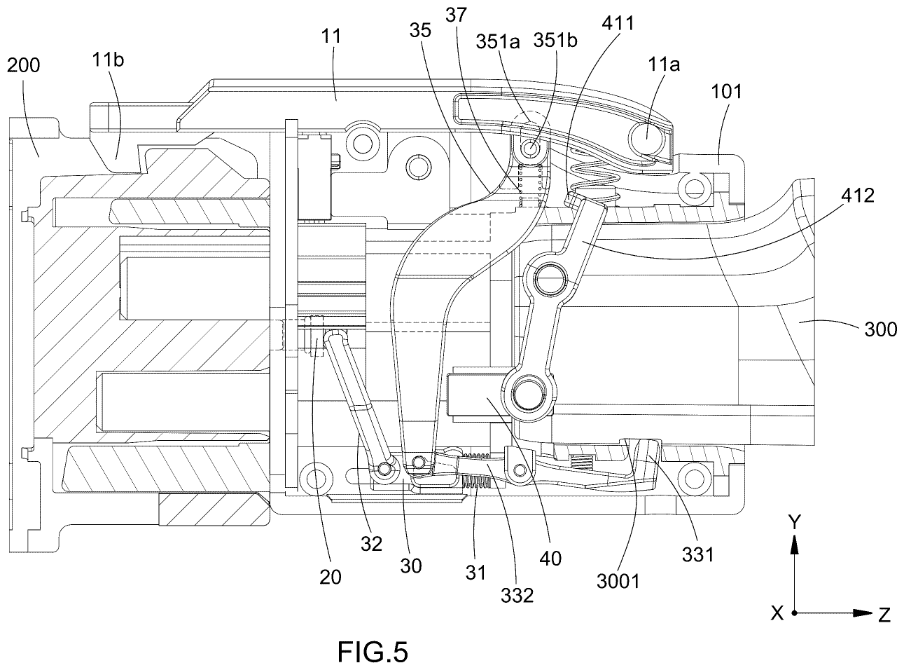

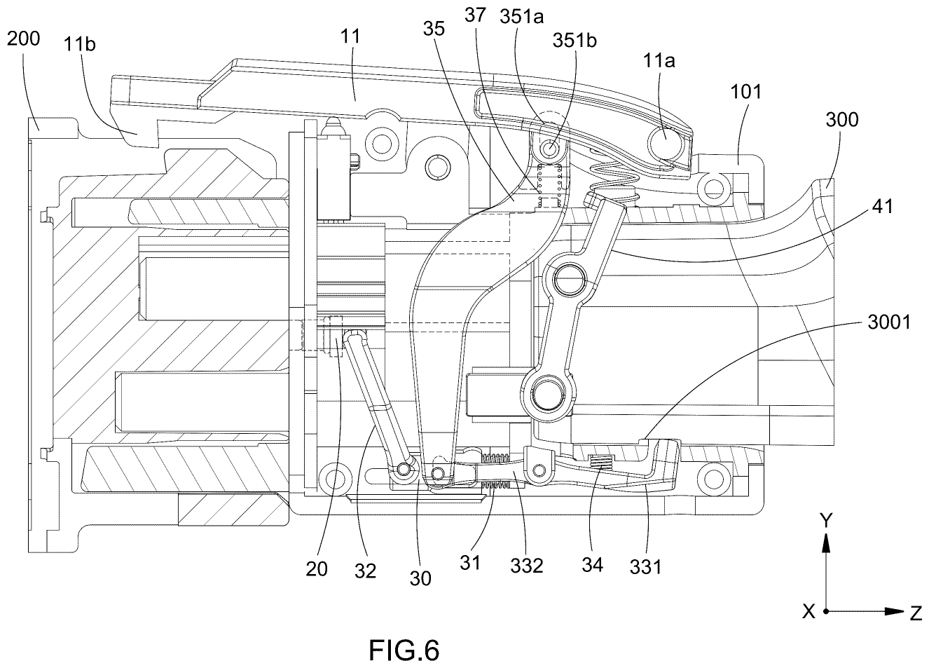

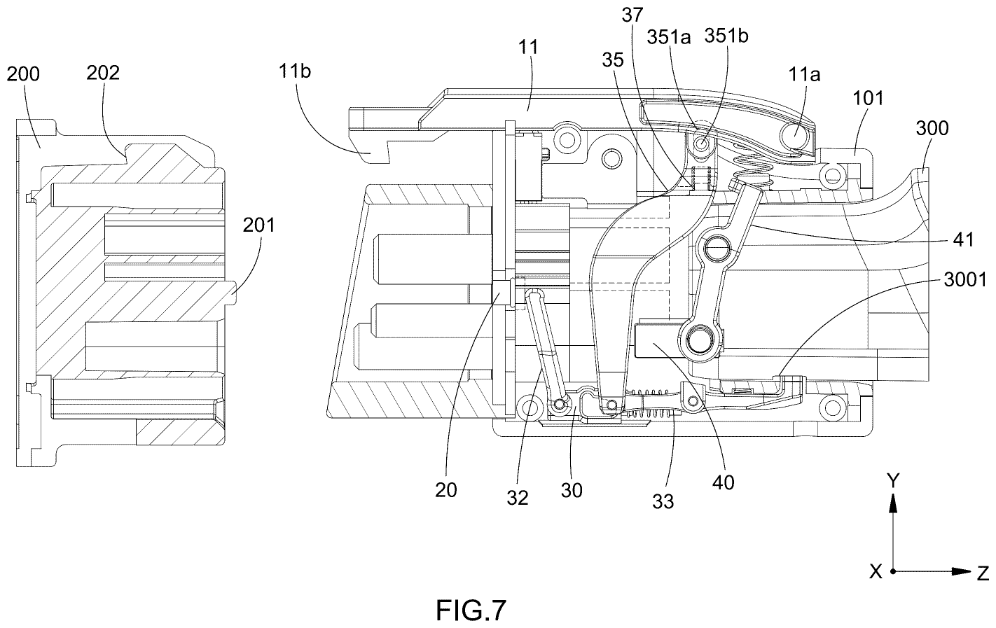

For further description, reference is made to FIGS. 5 to 7. When a user wishes to connect the adapter device 100 to the charging connector 300 and remove it from the mounting base 200, the charging connector 300 first be inserted into the adapter device 100. The charging connector 300 pushes the sliding protrusion 401, causing the limiting protrusion 411 of the limiting member 41 to swing away from the gap 36. At this time, the second connecting rod 302a is at the short side of the secondary alignment channel 302, and the axle rod 351b of the press button connector 35 is at the bottom of the sliding groove 351a (as shown in FIG. 5). Next, the user presses the press button 11, causing the hooking part 11b of the press button 11 to move upward away from the positioning part 202 of the mounting base 200 (as shown in the state of the press button 11 in FIG. 6). At this time, the axle rod 351b of the press button connector 35 moves downward to fit against the lower edge of the sliding groove 351a, causing the second connecting rod 302a to move toward the rear of the long side of the secondary alignment channel 302, making the press button connector 35 to swing downward. Then, with reference to FIG. 7, the user releases the push button 11 after pulling out the adapter device 100. At this time, the pushing block 20 returns to its original position because it's no longer being pushed, and at the same time, the spring 31 pushes the operating block 30 back to its original position. As a result, the connector locking mechanism 33 connected to the actuating block 30 also swings upward toward the interface converter 103, causing the positioning hook 331 to insert into the positioning groove 3001, locking the charging connector 300 with the adapter device 100, and the second connecting rod 302a then moves toward the front of the long side of the secondary alignment channel 302. Since the second connecting rod 302a is constrained by the secondary alignment channel 302, the press button connector 35 cannot swing up and down arbitrarily. In this state, the charging connector 300 is in a locked state and cannot be easily removed from the adapter device 100. For further description, when the user releases the press button 11, the sliding groove 351a serves as a buffer space to allow the axle rod 351b of the press button connector 35 to move upward within the sliding groove 351a.

For further description, the press button 11 has a keyhole 11a. In the charging state, users can additionally set a lock (not shown) in the keyhole 11a. Setting up a lock prevents the press button 11 from being pressed in charging state, preventing the adapter device 100 connected to the charging connector 300 from being removed by malicious persons, thereby achieving an anti-theft effect.

Based on the above, the present disclosure achieves its effects by providing a locking assembly inside the adapter device 100. When the adapter device 100 is connected to the mounting base 200 without being connected to the charging connector 300, it cannot be separated from the mounting base 200 by itself. It requires the connection of the charging connector 300 to push the sliding protrusion 401 so that the press button 11 can be pressed, thus allowing the adapter device 100 to be separated from the mounting base 200. Furthermore, it prevents users from inserting the adapter device 100 into vehicles without connecting the charging connector 300, thereby achieving a mistake-proofing effect.

What is claimed is:

1. An adapter device, comprising a body having an interface converter inside, where the rear end of the interface converter is an interface port and the front end is equipped with a docking connector, a locking assembly is provided on the outside of the interface converter, and a press button is provided on the outside of the body, wherein the locking assembly includes:
a pushing block;
an actuating block connected to a mounting base connector, a connector locking mechanism, and a press button connector, when the mounting base connector is pushed by the pushing block and swings toward the direction of the interface converter, the mounting base connector causes the actuating block to displace; and
at least one sliding block provided on either the left or right side of the interface converter, the at least one sliding block is connected to a limiting member and has a sliding protrusion protruding into the interface port of the interface converter, when the sliding protrusion is squeezed, the sliding block slides, causing the limiting member to swing away from the press button connector.

2. The adapter device according to claim 1, wherein the docking connector is connected to a mounting base, the mounting base has a pushing member, and the pushing member pushes the pushing block to move.

3. The adapter device according to claim 2, wherein the mounting base has a positioning part, the press button has a hooking part, and the hooking part is positioned in the positioning part.

4. The adapter device according to claim 1, wherein the interface converter is connected to a charging connector, the outer surface of the charging connector has a positioning groove, the connector locking mechanism has a positioning hook, and the positioning hook is positioned in the positioning groove.

5. The adapter device according to claim 1, wherein the limiting member has a limiting protrusion.

6. The adapter device according to claim 5, wherein the actuating block has a primary alignment track and a secondary alignment channel, a first connecting rod is provided in the primary alignment track, and a second connecting rod is provided in the secondary alignment channel.

7. The adapter device according to claim 6, wherein the press button connector has a connecting part and at least one swing arm, the at least one swing arm extending downward from the connecting part toward either the left or right side of the interface converter and being disposed on one side of the second connecting rod, while the connecting part is connected to the press button.

8. The adapter device according to claim 7, wherein a gap is provided between the connecting part of the press button connector and the interface converter, and when the sliding protrusion is not squeezed, the limiting protrusion of the limiting member is located within this gap.

9. The adapter device according to claim 8, wherein the connecting part of the press button connector has a sliding groove with an axle rod provided inside, and underneath the connecting part of the press button connector, a spring is also provided in the gap.

10. The adapter device according to claim 9, wherein the mounting base connector has a push part and at least one connecting arm, the at least one connecting arm extending downward from the push part toward either the left or right side of the interface converter and being disposed on one side of the first connecting rod, and the push part being adjacent to the pushing block.
